(19) United States
(12) Patent Application Publication
(10) Pub. No.: US 2008/0294697 A1
(43) Pub. Date: Nov. 27, 2008

(54) AUTOMATED DATA ARCHIVE TOOL

(75) Inventors: Michael J. Andrasak, Red Hook, NY (US); Chin-Ying Wang, Mohegan Lake, NY (US)

Correspondence Address: DELIO & PETERSON, LLC, 121 WHITNEY AVENUE, NEW HAVEN, CT, 06510, US

(73) Assignee: INTERNATIONAL BUSINESS MACHINES CORPORATION, Armonk, NY (US)

(21) Appl. No.: 11/751,695

(22) Filed: May 22, 2007

(51) Int. Cl. G06F 7/06; G06F 12/00; G06F 17/30

(52) U.S. Cl. 707/200; 707/E17.008; 707/E17.005

(57) ABSTRACT

A method and programmable storage device for controlling an archival process in a supply chain management software tool that includes using a control table to identify files or directories to be archived, and archiving information based on the data stored in each row of the control table. The method provides for the querying of archive control table rows by incrementally reading a row in the archive control table for an active column designation, storing the information from the row in a list if the active column designation is in a predetermined active state, and incrementing to a next row in the archive control table, or skipping the row if the active column designation is in a predetermined non-active state, and incrementing to a next row in the archive control table.

### BACKGROUND OF THE INVENTION

1. Field of the Invention

The invention is directed to a method of controlling an archival process in a supply chain management software tool. In particular, the invention is directed to control tables that identify files or directories to be archived.

2. Description of Related Art

Supply chain management is the process of planning, implementing, and controlling the operations of the supply chain with the purpose of satisfying customer requirements as efficiently as possible. Supply chain management spans all movement and storage of raw materials, work-in-process inventory, and finished goods from point-of-origin to point-of-consumption. The definition one America professional association put forward is that Supply Chain Management encompasses the planning and management of all activities involved in sourcing, procurement, conversion, and logistics management activities. Importantly, it also includes coordination and collaboration with channel partners, which can be suppliers, intermediaries, third-party service providers, and customers. In essence, Supply Chain Management integrates supply and demand management within and across companies.

In general, a supply chain involves any and all activities associated with defining, designing, producing, receiving, monitoring, storing, and using the components and sub-components used in manufacturing a product or providing a service. Manufacturers often find themselves paying higher prices, being short of product components in times of high demand, forecasting needs inaccurately, and creating slow moving inventories because they lack the expertise and resources to manage their supply chain properly. This management includes the ability to archive promptly and efficiently, important and necessary information.

A supply chain typically involves the flow of material, information, and money between customers, suppliers, manufacturers, and distributors, to name a few. In general, supply chains are utilized and monitored by methodologies designed for specific supply chain program software in order to provide users with real-time access to information about items in the supply chain. Generally, supply chain software enables permanent archival of all history to support reliability, warrantee, customer returns, proof of theft, and other business processes.

In U.S. Pat. No. 6,925,482, issued to Gopal, et al. on Aug. 2, 2005, entitled “ARCHIVAL DATABASE SYSTEM FOR HANDLING INFORMATION AND INFORMATION TRANSFERS IN A COMPUTER NETWORK,” a route point processor is used to archive points for messages transmitted between connectors. Specifically, when a message arrives at a route point processor, it is duplicated with the duplicate message redirected to an archival database. This duplication and redirection process is performed transparently to either the source or the destination connector. With the archival copy, delivery of the message to the destination connector becomes the responsibility of the route point processor even if the destination connector is down or is otherwise not accepting messages. The combination of the route point processor and archival database enables transport level acknowledgments to be used as the protocol between a source connector and the route point processor to establish proof of delivery.

The method of the present invention for automatically archiving information in a supply chain management system will allow for the archiving of data and information without requiring those people or companies using the supply chain software to create an additional instruction package or duplicate messages. The supply chain management system achieves this goal by being implemented on a comprehensive and reliable data communications network that serves as the foundation for the connectivity between the supply chain participants. The system includes a collection of functions and features implemented in software and/or hardware that make the operation and management of the supply chain as automated as possible.

### SUMMARY OF THE INVENTION

Bearing in mind the problems and deficiencies of the prior art, it is therefore an object of the present invention to provide a method and software tool to automatically archive information in a supply chain management program that creates archived information based on the contents in a control table.

It is another object of the present invention to provide a method and software tool for automatically archiving information in a supply chain management system without requiring those people or companies using the supply chain software to create an additional instruction package or duplicate messages.

Still other objects and advantages of the invention will in part be obvious and will in part be apparent from the specification.

The above and other objects, which will be apparent to those skilled in the art, are achieved in the present invention which is directed to in a first aspect, a method for automating the archiving of data in a supply chain software tool comprising: generating via software code in the supply chain software tool an archive control table having a plurality of rows; querying the archive control table rows by incrementally reading a row in the archive control table for an active column designation; storing information from the row in a list if the active column designation is in a predetermined active state, and incrementing to a next row in the archive control table, or skipping the row if the active column designation is in a predetermined non-active state, and incrementing to a next row in the archive control table; generating a list of rows having active column designations; and determining if an additional column needs to be added to an archived table having a table name, including: comparing a first and second predetermined identifier; copying the archived table if the first and second predetermined identifiers are not equal, or copying the archived table and adding the additional column if the first and second predetermined identifiers are equal; and inserting the first predetermined identifier value into the additional column.

In a second aspect, the present invention is directed to a program storage device readable by a machine, tangibly embodying a program of instructions executable by the machine to perform method steps of the first aspect defined above for automating the archiving of data in supply chain software, the method steps comprising: generating via software code in said supply chain software tool an archive control table having a plurality of rows; querying said archive control table rows by incrementally reading a row in said archive control table for an active column designation; storing information from said row in a list if said active column designation is in a predetermined active state, and incrementing to a next row in said archive control table, or skipping said row if said active column designation is in a predetermined non-active state, and incrementing to a next row in said archive control table; generating a list of rows having active column designations; and determining if an additional column needs to be added to an archived table having a table name, including: comparing a first and second predetermined identifier; copying said archived table if said first and second predetermined identifiers are not equal, or copying said archived table and adding said additional column if said first and second predetermined identifiers are equal; and inserting said first predetermined identifier value into said additional column.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a flow chart presenting the archive tool of the present invention.

FIG. 2 is a continuation of the flow chart of FIG. 1.

FIG. 3 is a continuation of the flow chart of FIG. 2.

Table I represents the input and destination archive information based on the archival action designator.

### DESCRIPTION OF THE PREFERRED EMBODIMENTS(S)

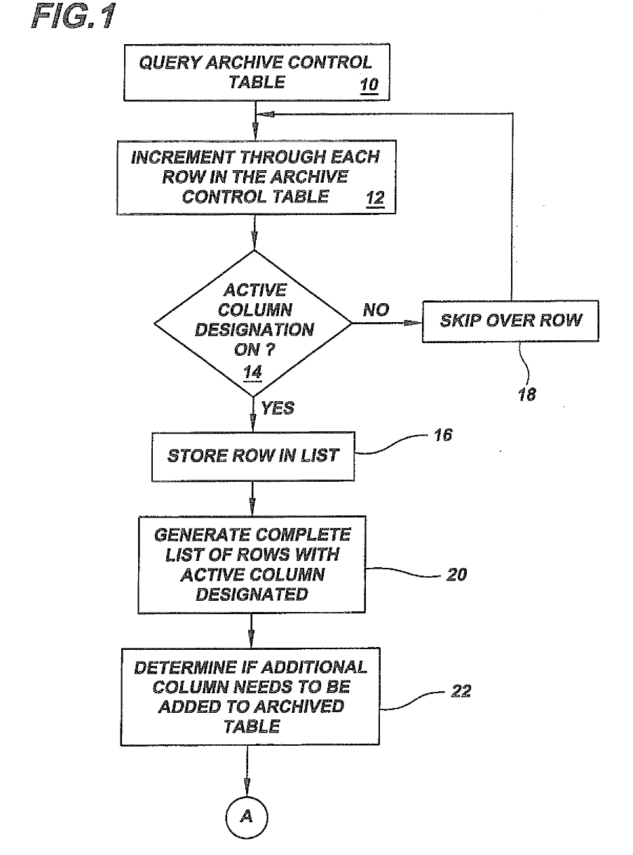

In describing the preferred embodiment of the present invention, reference will be made herein to FIGS. 1-3 and Table I of the drawings in which like numerals refer to like features of the invention.

In order to copy DB2 tables to an archive version of the same, the present invention explicitly defines the export and import statements for each table. This process notes that the tables are to be copied and utilizes the DB2 System tables as a source of specific table layouts so that table copying may be executed without having to generate additional software code for table specific information. Thus, the present invention allows for the copying of DB2 tables to an archive version without coding for source and target table layouts. This creates an advantage where adding the tables to be copied only requires an additional entry on a control table, with the proviso that the table layouts of the two tables are similar.

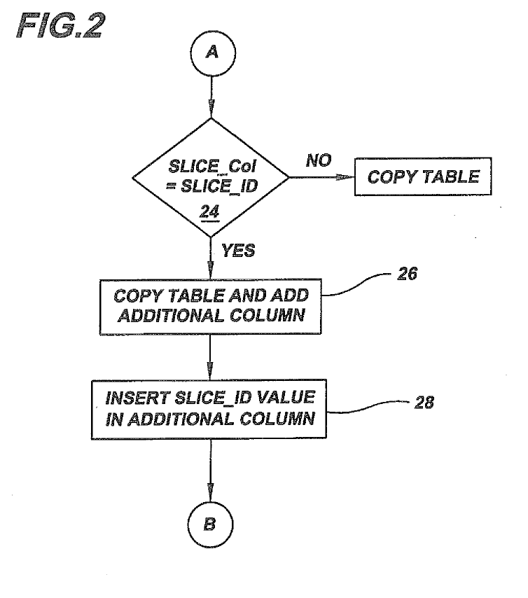

The method of the present invention is shown in FIG. 1. An archive control table is queried 10 in order to ultimately construct a list of tables selected for archiving. The query requires that each row in the archive control table be read under certain defined conditions 12. The row is listed if a given value in a predetermined column is active. For example, an ACTIVE column may have a “Y” or “N” designation 14. If “Y” is read, the row is listed 16. If the ACTIVE column for the row has an “N” value, the process skips over this row, and ignores the information contained therein 18. In this instance, no archive record is created for the table identified in this row. Once this process is completed, a list of rows having a “Y” in the ACTIVE column is generated 20. The list is read for predetermined values in two separate columns to determine if an additional column needs to be added to the archived table under investigation 22. As depicted in FIG. 2, the columns have been arbitrarily named “Slice_Col” and “Slice_ID”, although such names have no affect on the operation of the present method. The Slice_Col refers to the column name that will be filled with the slice_id upon archival. The Slice_ID refers to the actual column name the column must have if the SLICE_ID value is to be archived along with the table. A comparison is made of the column name 24. When the value in the Slice_Col is equal to “SLICE_ID” the table associated with the identified row will be copied and an additional column will be added 26 to insert the Slice_ID value 28. If the Slice_Col value is equal to a null value, or other predetermined value, the table will be copied, but no additional column will be added.

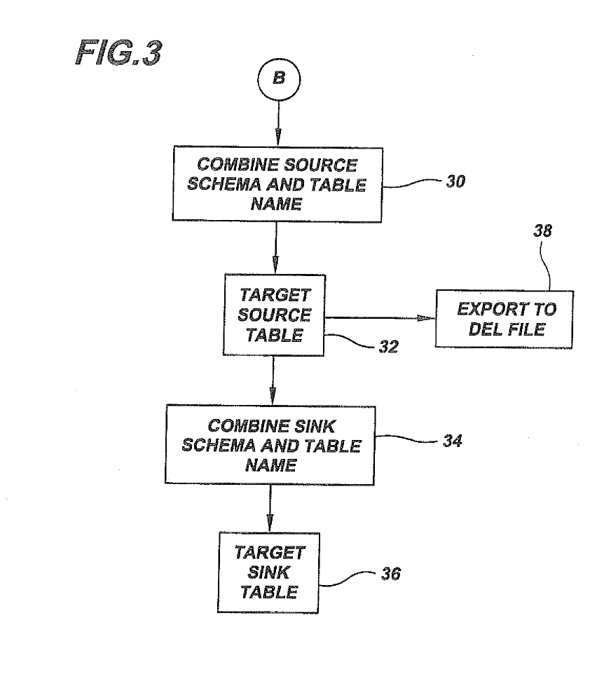

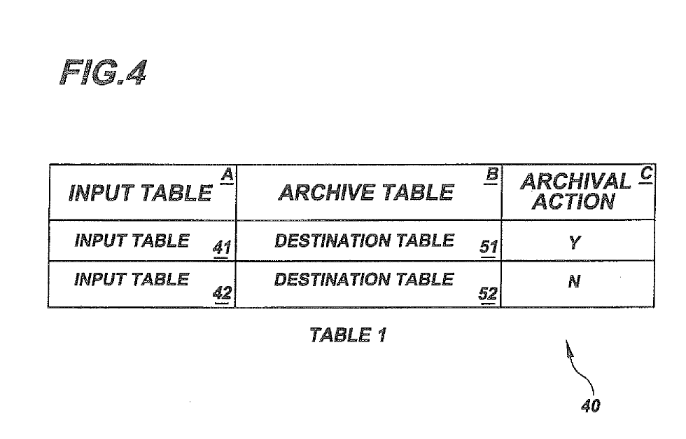

Referring to FIG. 3, the source schema and table name are then combined 30 and designated as the target source table 32. The sink schema and table name are combined 34 and designated as the target sink table 36. The table located at the target source table is exported to a DEL file 38 and value added formatting is provided to allow the addition of a column, which can hold the Slice_ID value. This facilitates the historical or vintage identification of the archive. The additional column containing the Slice_ID information is added to each DEL file. The DB2 syscat tables are queried to determine the column names for the archive table into which the del file will be imported. The import statement is then generated from this information. The del file is then imported into the archive table. Multiple versions of data will be contained in a single archive table. Each archive version of data is determined by the value in the SLICE_ID column.

Each table that is archived will have a corresponding archive version generated by the present method. All column information for the source and target tables may be derived from the DB2 syscat tables.

In order to control the archival process in a supply chain management software tool, such as DB2, the present invention provides for one or more control tables that identify files or directories that need to be archived. In general, the control table includes a first column of input data, such as tables, files, and directories; a second column identifying the archive destination (table, file, or directory); and a third column of flags indicating whether the user desires the archival process. Table I illustrates the pertinent columns for a control table 40 of the present invention. Control table 40 is shown with at least three columns A, B, and C, identifying the Input Table, Archive Table, and Archival Action, respectively. Implementation of the information contained in control table 40 would cause an archival software module to copy the contents of input table 41 into destination table 51 because the Action column C or action flag has a “Y” value designated. However, the content of input table 42 would not be copied into destination table 52 because the corresponding Active column C has an “N” value designated. The use of a control table utilizing an action flag in this manner is novel to the art.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A method for automating the archiving of data in a supply chain software tool comprising:
generating via software code in said supply chain software tool an archive control table having a plurality of rows;
querying said archive control table rows by incrementally reading a row in said archive control table for an active column designation;
storing information from said row in a list if said active column designation is in a predetermined active state, and incrementing to a next row in said archive control table, or skipping said row if said active column designation is in a predetermined non-active state, and incrementing to a next row in said archive control table;
generating a list of rows having active column designations; and
determining if an additional column needs to be added to an archived table having a table name, including:
comparing a first and second predetermined identifier;
copying said archived table if said first and second predetermined identifiers are not equal, or copying said archived table and adding said additional column if said first and second predetermined identifiers are equal; and
inserting said first predetermined identifier value into said additional column.

2. The method of claim 1 wherein said archive control table rows include the identification of DB2 tables, files, or directories.

3. The method of claim 1 including:
combining a source schema and said table name to generate a target source table;
combining a sink schema and said table name to generate a target sink table; and
exporting said target source table to a DEL file.

4. The method of claim 1 wherein said step of copying said archived table includes generating an input table and a destination table.

5. The method of claim 1 wherein said step of storing information from said row in a list if said active column designation is in a predetermined active state includes having said predetermined active state equal to a first predetermined value.

6. The method of claim 5 wherein said step of skipping said row if said active column designation is in a predetermined non-active state includes have said predetermined non-active state equal to a second predetermined value not equal to said first predetermined value.

7. A program storage device readable by a machine, tangibly embodying a program of instructions executable by the machine to perform method steps for automating the archiving of data in supply chain software, said method steps comprising:
generating via software code in said supply chain software tool an archive control table having a plurality of rows;
querying said archive control table rows by incrementally reading a row in said archive control table for an active column designation;
storing information from said row in a list if said active column designation is in a predetermined active state, and incrementing to a next row in said archive control table, or skipping said row if said active column designation is in a predetermined non-active state, and incrementing to a next row in said archive control table;
generating a list of rows having active column designations; and
determining if an additional column needs to be added to an archived table having a table name, including:
comparing a first and second predetermined identifier;
copying said archived table if said first and second predetermined identifiers are not equal, or copying said archived table and adding said additional column if said first and second predetermined identifiers are equal; and
inserting said first predetermined identifier value into said additional column.

8. The program storage device of claim 6 including:
combining a source schema and said table name to generate a target source table;
combining a sink schema and said table name to generate a target sink table; and
exporting said target source table to a DEL file.
